(19) United States
(12) Patent Application Publication
(10) Pub. No.: US 2026/0088876 A1
(43) Pub. Date: Mar. 26, 2026

(54) RELAXED TIMELINE FOR APERIODIC CHANNEL STATE INFORMATION REPORTING ON AN UPLINK SHARED CHANNEL

(71) Applicant: QUALCOMM Incorporated, San Diego, CA (US)

(72) Inventors: Alireza SANI, San Diego, CA (US); Linda BAI, Los Altos, CA (US); Paolo MINERO, La Jolla, CA (US); Enoch Shiao-Kuang LU, San Diego, CA (US); Lei XIAO, San Jose, CA (US); Yi HUANG, San Diego, CA (US)

(21) Appl. No.: 19/306,844

(22) Filed: Aug. 21, 2025

Related U.S. Application Data
(60) Provisional application No. 63/698,488, filed on Sep. 24, 2024.

(51) Int. Cl. H04B 7/06; H04W 24/10

(52) U.S. Cl. CPC H04B 7/0626; H04B 7/0639; H04W 24/10

(57) ABSTRACT

Methods, systems, and devices for wireless communications are described. A user equipment (UE) may transmit capability signaling indicating a power saving capability associated with two-part channel state information (CSI) reporting. The UE may receive, based on the capability signaling, control signaling including information triggering two-part aperiodic (AP)-CSI reporting. The UE may generate at least a part of the two-part AP-CSI report in accordance with a timeline. The timeline may be in accordance with the control signaling, and may differ from a default timeline associated with non-power saving CSI reporting. The UE may transmit at least the part of the two-part AP-CSI report via an uplink shared channel in accordance with the timeline. The UE may receive the control signaling in a first processing unit state and may transition to a second processing unit state associated with a faster processing speed to generate the two-part AP-CSI report.

### CROSS REFERENCES

The present Application for Patent claims benefit of U.S. Provisional Ser. No. 63/698,488 by SANI et al., entitled “RELAXED TIMELINE FOR APERIODIC CHANNEL STATE INFORMATION REPORTING ON AN UPLINK SHARED CHANNEL,” filed Sep. 24, 2024, assigned to the assignee hereof, and expressly incorporated herein.

### FIELD OF TECHNOLOGY

The following relates to wireless communications, including relaxed timeline for aperiodic channel state information (AP-CSI) reporting on an uplink shared channel.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting capability signaling indicating a power saving capability associated with two-part channel state information reporting, receiving, based on the capability signaling, control signaling including information triggering aperiodic two-part CSI reporting, generating, based on the power saving capability, a part of a two-part CSI report in accordance with a first timeline indicated by control signaling, where the timeline differs from a second timeline associated with non-power saving CSI reporting, and transmitting at least the generated part of the two-part CSI report via an uplink shared channel in accordance with the first timeline.

A UE for wireless communications is described. The UE may include one or more memories storing processor executable code, and one or more processors coupled with the one or more memories. The one or more processors may individually or collectively be operable to execute the code to cause the UE to transmit capability signaling indicating a power saving capability associated with two-part CSI reporting, receive, based on the capability signaling, control signaling including information triggering aperiodic two-part CSI reporting, generate, based on the power saving capability, a part of a two-part CSI report in accordance with a first timeline indicated by control signaling, where the timeline differs from a second timeline associated with non-power saving CSI reporting, and transmit at least the generated part of the two-part CSI report via an uplink shared channel in accordance with the first timeline.

Another UE for wireless communications is described. The UE may include means for transmitting capability signaling indicating a power saving capability associated with two-part CSI reporting, means for receiving, based on the capability signaling, control signaling including information triggering aperiodic two-part CSI reporting, means for generating, based on the power saving capability, a part of a two-part CSI report in accordance with a first timeline indicated by control signaling, where the timeline differs from a second timeline associated with non-power saving CSI reporting, and means for transmitting at least the generated part of the two-part CSI report via an uplink shared channel in accordance with the first timeline.

A non-transitory computer-readable medium storing code for wireless communications is described. The code may include instructions executable by one or more processors to transmit capability signaling indicating a power saving capability associated with two-part CSI reporting, receive, based on the capability signaling, control signaling including information triggering aperiodic two-part CSI reporting, generate, based on the power saving capability, a part of a two-part CSI report in accordance with a first timeline indicated by control signaling, where the timeline differs from a second timeline associated with non-power saving CSI reporting, and transmit at least the generated part of the two-part CSI report via an uplink shared channel in accordance with the first timeline.

In some examples of the method, UEs, and non-transitory computer-readable medium described herein, receiving the control signaling may include operations, features, means, or instructions for receiving an indication of a quantity of symbols of the first timeline, where the quantity of symbols of the first timeline may be greater than a quantity of symbols of the second timeline associated with non-power saving CSI reporting.

In some examples of the method, UEs, and non-transitory computer-readable medium described herein, the indication of the quantity of symbols of the first timeline includes an additional quantity of symbols relative to the quantity of symbols of the second timeline.

In some examples of the method, UEs, and non-transitory computer-readable medium described herein, generating the generated part of the two-part CSI report may include operations, features, means, or instructions for processing a first portion of the two-part CSI report prior to starting a processing of a second portion of the two-part CSI report, where processing the first portion of the two-part CSI report may be independent of rank information associated with one or more CSI reference signals (CSI-RSs) and processing the second portion of the two-part CSI report based on the rank information associated with the one or more CSI-RSs.

In some examples of the method, UEs, and non-transitory computer-readable medium described herein, generating the generated part of the two-part CSI report may include operations, features, means, or instructions for puncturing a payload of the two-part CSI report.

In some examples of the method, UEs, and non-transitory computer-readable medium described herein, transmitting the generated part of the two-part CSI report may include operations, features, means, or instructions for transmitting, based on the power saving capability, the generated part of the two-part CSI report using an assumed rank for a portion of the two-part CSI report.

In some examples of the method, UEs, and non-transitory computer-readable medium described herein, the first timeline may be based on a quantity of symbols after receiving the control signaling, a quantity of symbols after receiving a CSI-RS, or both.

In some examples of the method, UEs, and non-transitory computer-readable medium described herein, the first timeline may be based on the control signaling, based on static configuration information, or a combination thereof.

In some examples of the method, UEs, and non-transitory computer-readable medium described herein, the generated part of the two-part CSI report includes a second part of the two-part CSI report, the second part of the two-part CSI report includes at least a precoding matrix indicator, and a first part of the two-part CSI report includes at least an indication of a number of information bits associated with the second part of the two-part CSI report.

A method for wireless communications by a UE is described. The method may include receiving, while in a first processing unit state associated with a first processing speed, control signaling triggering aperiodic two-part CSI reporting, where the control signaling instructs the UE to generate a two-part CSI report within a first timeline, transitioning, based on the control signaling, from the first processing unit state to a second processing unit state associated with a second processing speed, the second processing speed faster than the first processing speed, generating, based on the control signaling and while in the second processing unit state, a part of the two-part CSI report within the first timeline, and transmitting the generated part of the two-part CSI report via an uplink shared channel.

A UE for wireless communications is described. The UE may include one or more memories storing processor executable code, and one or more processors coupled with the one or more memories. The one or more processors may individually or collectively be operable to execute the code to cause the UE to receive, while in a first processing unit state associated with a first processing speed, control signaling triggering aperiodic two-part CSI reporting, where the control signaling instructs the UE to generate a two-part CSI report within a first timeline, transition, based on the control signaling, from the first processing unit state to a second processing unit state associated with a second processing speed, the second processing speed faster than the first processing speed, generate, based on the control signaling and while in the second processing unit state, a part of the two-part CSI report within the first timeline, and transmit the generated part of the two-part CSI report via an uplink shared channel.

Another UE for wireless communications is described. The UE may include means for receiving, while in a first processing unit state associated with a first processing speed, control signaling triggering aperiodic two-part CSI reporting, where the control signaling instructs the UE to generate a two-part CSI report within a first timeline, means for transitioning, based on the control signaling, from the first processing unit state to a second processing unit state associated with a second processing speed, the second processing speed faster than the first processing speed, means for generating, based on the control signaling and while in the second processing unit state, a part of the two-part CSI report within the first timeline, and means for transmitting the generated part of the two-part CSI report via an uplink shared channel.

A non-transitory computer-readable medium storing code for wireless communications is described. The code may include instructions executable by one or more processors to receive, while in a first processing unit state associated with a first processing speed, control signaling triggering aperiodic two-part CSI reporting, where the control signaling instructs the UE to generate a two-part CSI report within a first timeline, transition, based on the control signaling, from the first processing unit state to a second processing unit state associated with a second processing speed, the second processing speed faster than the first processing speed, generate, based on the control signaling and while in the second processing unit state, a part of the two-part CSI report within the first timeline, and transmit the generated part of the two-part CSI report via an uplink shared channel.

In some examples of the method, UEs, and non-transitory computer-readable medium described herein, the first timeline may be based on a quantity of symbols after receiving the control signaling, a quantity of symbols after receiving a CSI-RS, or both.

In some examples of the method, UEs, and non-transitory computer-readable medium described herein, the generated part of the two-part CSI report includes a second part of the two-part CSI report, the second part of the two-part CSI report includes at least a precoding matrix indicator, and a first part of the two-part CSI report includes at least an indication of a number of information bits associated with the second part of the two-part CSI report.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports relaxed timeline for aperiodic channel state information (AP-CSI) reporting on an uplink shared channel in accordance with one or more aspects of the present disclosure.

FIG. 2 shows an example of a wireless communications system that supports relaxed timeline for AP-CSI reporting on an uplink shared channel in accordance with one or more aspects of the present disclosure.

FIG. 3 shows an example of a timing diagram that supports relaxed timeline for AP-CSI reporting on an uplink shared channel in accordance with one or more aspects of the present disclosure.

FIG. 4 shows an example of a timing diagram that supports relaxed timeline for AP-CSI reporting on an uplink shared channel in accordance with one or more aspects of the present disclosure.

FIG. 5 shows an example of a timing diagram that supports relaxed timeline for AP-CSI reporting on an uplink shared channel in accordance with one or more aspects of the present disclosure.

FIG. 6 shows an example of a timing diagram that supports relaxed timeline for AP-CSI reporting on an uplink shared channel in accordance with one or more aspects of the present disclosure.

FIG. 7 shows an example of a process flow that supports relaxed timeline for AP-CSI reporting on an uplink shared channel in accordance with one or more aspects of the present disclosure.

FIGS. 8 and 9 show block diagrams of devices that support relaxed timeline for AP-CSI reporting on an uplink shared channel in accordance with one or more aspects of the present disclosure.

FIG. 10 shows a block diagram of a communications manager that supports relaxed timeline for AP-CSI reporting on an uplink shared channel in accordance with one or more aspects of the present disclosure.

FIG. 11 shows a diagram of a system including a device that supports relaxed timeline for AP-CSI reporting on an uplink shared channel in accordance with one or more aspects of the present disclosure.

FIGS. 12 and 13 show flowcharts illustrating methods that support relaxed timeline for AP-CSI reporting on an uplink shared channel in accordance with one or more aspects of the present disclosure.

### DETAILED DESCRIPTION

In some wireless communications systems, a network entity may request (e.g., via a downlink control information (DCI) message) a user equipment (UE) to transmit aperiodic channel state information (AP-CSI) reports via a physical uplink shared channel (PUSCH). The UE may be configured to process (e.g., prepare for transmission) an AP-CSI report within a default timeline (e.g., second timeline) defined as the later of a first deadline Z or a second deadline Z′. The first deadline Z may be based on a quantity of symbols after the last symbol of a physical downlink control channel (PDCCH) carrying the AP-CSI request. The second deadline Z′ may be based on a quantity of symbols after the end of a CSI reference signal (CSI-RS). However, such a default timeline may assume that (1) the uplink preparation based on the DCI (e.g., uplink processing) and (2) the CSI-RS processing at the UE (e.g., downlink processing) are parallelized, which may be the case for periodic CSI reports on a physical uplink control channel (PUCCH) but not for some AP-CSI reports on PUSCH. For example, an AP-CSI report may include a first part and a second part, where payload rate matching of the second part may depend on rank information determined from the CSI-RS. In such examples, uplink rate matching computation may be serialized after the CSI-RS signal processing (e.g., instead of parallelized), leading to timeline deficiency and power deficiency.

In some implementations, a UE may use a relaxed timeline (e.g., first timeline) for two-part AP-CSI reporting on PUSCH. For example, a UE may receive an indication of a deadline extension, such as a quantity of symbols in addition to the default timeline (e.g., a quantity of symbols in addition to the first deadline Z, the second deadline Z′, or both) by which the UE is to transmit a two-part AP-CSI report. In some examples, the UE may use puncturing instead of rate matching for the payload of the two-part AP-CSI report. For example, the UE may process a first portion of the two-part AP-CSI report before completion of CSI-RS processing, independent of rank information determined from the CSI-RS. In some examples, the UE may parallelize the downlink processing and the uplink processing by assuming rank information for rate matching part of the two-part AP-CSI report. Thus, the UE may transmit the AP-CSI report via PUSCH while retaining the timeline of a periodic CSI report via PUCCH. In some examples, the UE may bump clock (e.g., switch from a first processor state to a second processor state associated with a faster processing speed) to generate the two-part AP-CSI report within the default timeline defined by the first deadline Z and the second deadline Z′.

Particular aspects of the subject matter described herein may be implemented to realize one or more potential advantages. The described techniques may provide for reduced power consumption and more efficient utilization of communication resources, longer battery life, and improved utilization of processing capability. For example, by extending a deadline for the UE to prepare and transmit a two-part AP-CSI report, the UE may be able to use a processor unit state associated with relatively low processing speed and decreased power consumption.

Aspects of the disclosure are initially described in the context of wireless communications systems. Aspects of the disclosure are then described in the context of timing diagrams and a process flow. Aspects of the disclosure are further illustrated by and described with reference to apparatus diagrams, system diagrams, and flowcharts that relate to relaxed timeline for AP-CSI reporting on an uplink shared channel.

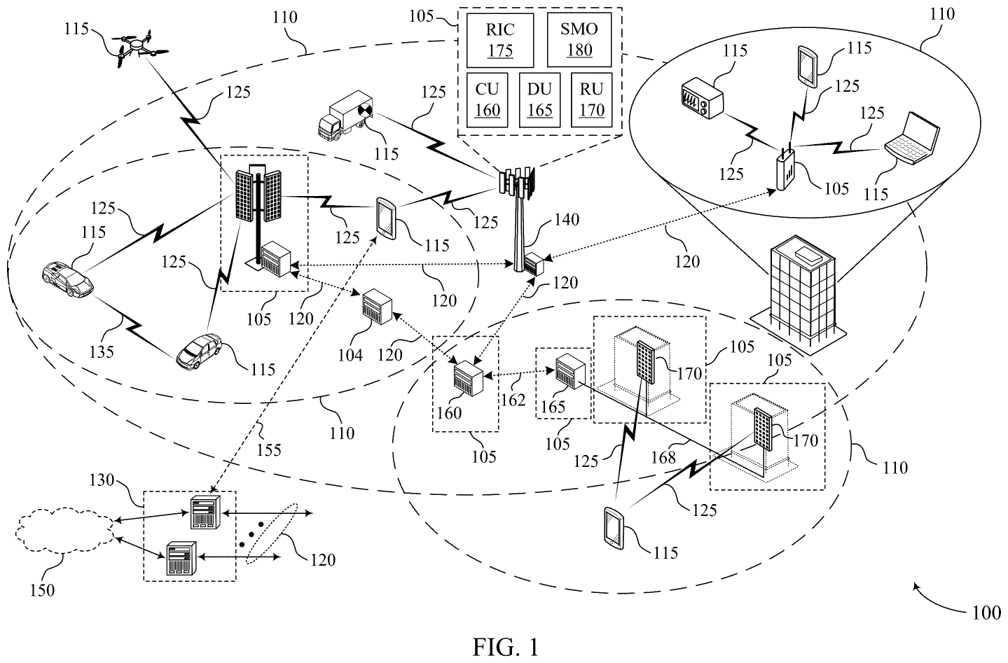

FIG. 1 shows an example of a wireless communications system 100 that supports relaxed timeline for AP-CSI reporting on an uplink shared channel in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support relaxed timeline (e.g., first timeline) for AP-CSI reporting on an uplink shared channel as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

In the wireless communications system 100, a network entity 105 may request (e.g., via a DCI message) a UE 115 to transmit AP-CSI reports via a PUSCH. The UE 115 may be configured to process (e.g., prepare for transmission) an AP-CSI report within a default timeline (e.g., second timeline) defined as the later of a first deadline Z or a second deadline Z′. The first deadline Z may be based on a quantity of symbols after the last symbol of a PDCCH carrying the AP-CSI request. The second deadline Z′ may be based on a quantity of symbols after the end of a CSI-RS. However, such a default timeline may assume that (1) the uplink preparation based on the DCI (e.g., uplink processing) and (2) the CSI-RS processing at the UE 115 (e.g., downlink processing) are parallelized, which may be the case for periodic CSI reports on PUCCH but not for some AP-CSI reports on PUSCH. For example, an AP-CSI report may include a first part and a second part, where payload rate matching of the second part may depend on rank information determined from the CSI-RS. In such examples, uplink rate matching computation may be serialized after the CSI-RS signal processing (e.g., instead of parallelized), leading to timeline deficiency and power deficiency.

In some implementations, a UE 115 in the wireless communications system 100 may use a relaxed timeline (e.g., first timeline) for two-part AP-CSI reporting on PUSCH. For example, a UE 115 may receive an indication of a deadline extension, such as a quantity of symbols in addition to the default timeline (e.g., a quantity of symbols in addition to the first deadline Z, the second deadline Z′, or both) by which the UE 115 is to transmit a two-part AP-CSI report. In some examples, the UE 115 may use puncturing instead of rate matching for the payload of the two-part AP-CSI report. For example, the UE 115 may process a first portion of the two-part AP-CSI report before completion of CSI-RS processing, independent of rank information determined from the CSI-RS. In some examples, the UE 115 may parallelize the downlink processing and the uplink processing by assuming rank information for rate matching part of the two-part AP-CSI report. Thus, the UE 115 may transmit the AP-CSI report via PUSCH while retaining the timeline of a periodic CSI report via PUCCH. In some examples, the UE 115 may bump clock (e.g., switch from a first processor state to a second processor state associated with a faster processing speed) to generate the two-part AP-CSI report within the default timeline defined by the first deadline Z and the second deadline Z′.

Particular aspects of the subject matter described herein may be implemented to realize one or more potential advantages. The described techniques may provide for reduced power consumption and more efficient utilization of communication resources, longer battery life, and improved utilization of processing capability. For example, by extending a deadline for the UE 115 to prepare and transmit a two-part AP-CSI report, the UE 115 may be able to use a processor unit state associated with relatively low processing speed and decreased power consumption.

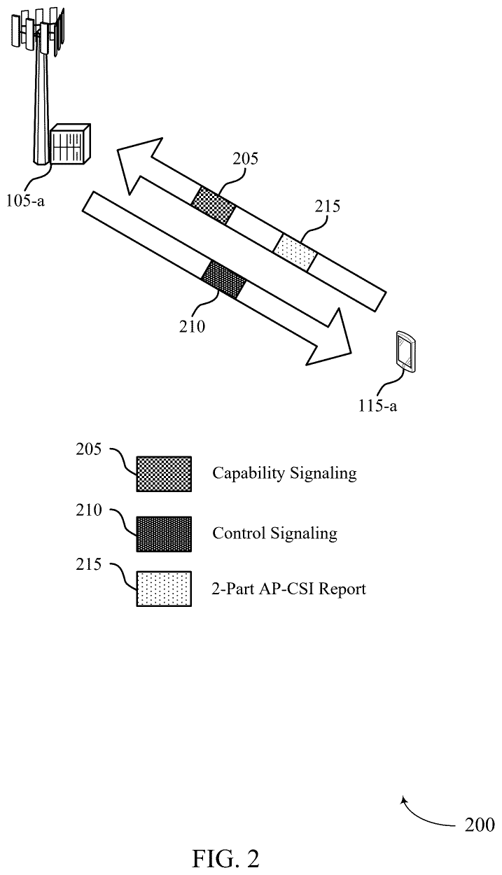

FIG. 2 shows an example of a wireless communications system 200 that supports relaxed timeline for AP-CSI reporting on an uplink shared channel in accordance with one or more aspects of the present disclosure. In some examples, the wireless communications system 200 may implement aspects of the wireless communications system 100. For example, the wireless communications system 200 includes a UE 115-a and a network entity 105-a, which may be examples of the corresponding devices described with reference to FIG. 1. Additionally, or alternatively, the UE 115-a and the network entity 105-a may each be examples of other types of wireless devices, such as an IAB node or another type of transmitter or receiver. Thus, although aspects of the present disclosure are described with reference to a UE 115 and a network entity 105, it is understood that the described techniques may be performed by a wireless device different from a UE 115 and a network entity 105. As described herein, operations performed by the UE 115-a and the network entity 105-a may be respectively performed by a UE 115, a network entity 105, or another wireless device, and the examples shown should not be construed as limiting.

Note that throughout the present disclosure, terms such as “the CSI report,” “the two-part AP-CSI report,” and “the two-part CSI report” may not be limited to the entirety of a CSI report. For example, “the two-part AP-CSI report” may refer to a first part of the two-part AP-CSI report, a second part of the two-part AP-CSI report, a portion of the first part of the two-part AP-CSI report, a portion of the second part of the two-part AP-CSI report, or any combination thereof. The examples described herein should not be construed as limiting.

In some wireless communications systems, a network (e.g., via the network entity 105-a) may request a UE (e.g., the UE 115-a) to send one or more AP-CSI reports when one or more CSI resources are set (e.g., configured) to periodic, semi-periodic, or aperiodic. The UE may be configured to finish processing (e.g., finish generating, begin transmitting) the one or more AP-CSI reports on an uplink channel within a timeline or by a deadline. In some cases, the deadline for aperiodic CSI resources may be the same as a deadline for periodic CSI resources, but the procedure for determining the deadline may be different. In some examples, a CSI request may be downlink grant-based, such that the network entity 105-a sends a request asking the UE 115-a to transmit aperiodic channel state feedback (AP-CSF). In some other examples, the UE 115-a may periodically transmit CSF based on an RRC configuration. Additionally, or alternatively, the CSI request (e.g., an AP-CSI request) may be DCI-based (e.g., transmitted via a DCI message). For example, when triggered by a DCI message (e.g., or another type of control signaling), the UE 115-a may be configured to send (e.g., transmit, multiplex) one or more CSI reports on a PUSCH.

According to a default timeline (e.g., second timeline) for non-power saving AP-CSI reporting, the UE 115-a may receive a grant via a downlink control channel (e.g., PDCCH) requesting a CSI report. For example, the network entity 105-a may transmit or output, to the UE 115-a, control signaling 210 (e.g., a DCI message) providing information such as which CSI-RS to use and on which slot to transmit at least a portion of a two-part AP-CSI report 215 (e.g., an indication of the default timeline). After receiving the PDCCH containing the control signaling 210, the UE 115-a may process the control signaling 210 (e.g., decode the DCI message) as part of UE downlink processing. While the UE 115-a is processing the DCI message, the UE 115-a may receive one or more CSI-RSs. After receiving or measuring the one or more CSI-RSs, the UE 115-a may process (e.g., as part of UE downlink processing) the one or more CSI-RSs to determine a channel quality (e.g., to include in the two-part AP-CSI report 215). Before the UE 115-a can transmit the two-part AP-CSI report 215, the UE 115-a may perform UE uplink processing to prepare or generate the two-part AP-CSI report 215. For example, the UE 115-a may determine which slot (e.g., a first slot) in which to transmit the two-part AP-CSI report 215, a slot format of the first slot, which symbols are uplink symbols, which symbols are downlink symbols, what power to use to transmit the two-part AP-CSI report 215, a processing unit state and associated processing speed to use to transmit the two-part AP-CSI report 215, other processing information, or a combination thereof. According to the default timeline and for AP-CSI processing, such information may depend on the CSI-RS signal processing. For example, the UE 115-a may determine a rank based on the CSI-RS signal processing, and therefore determine the symbol in which to transmit the two-part AP-CSI report 215, how many symbols to use to transmit the two-part AP-CSI report 215, how many information bits to use to transmit the two-part AP-CSI report 215, and other information. Thus, according to a default timeline for AP-CSI reporting, the UE 115-a is gated such that the UE 115-a may not start preparing or generating the two-part AP-CSI report 215 until after completion of CSI-RS processing.

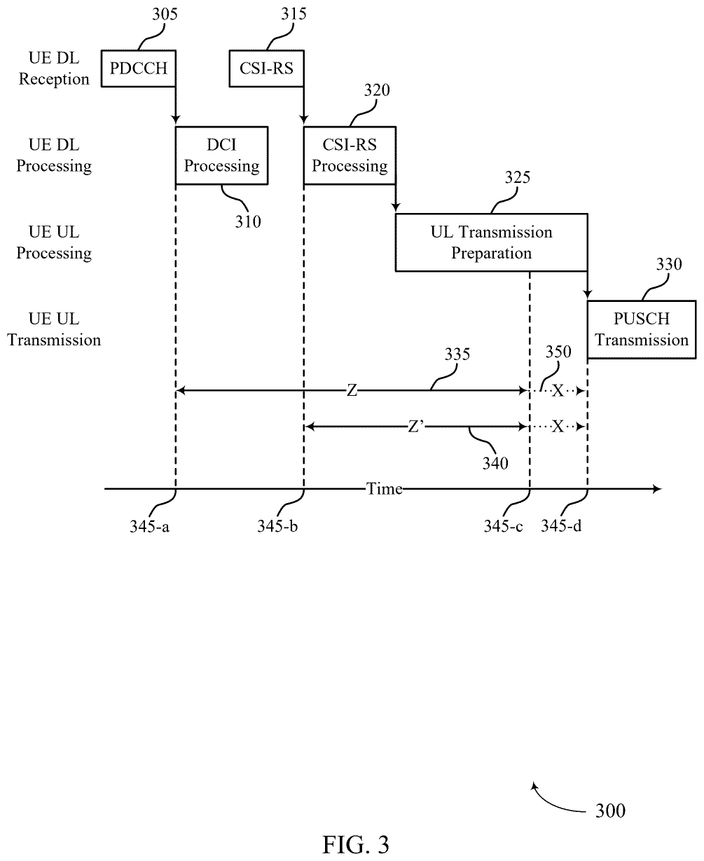

In some examples, the UE 115-a may be configured to process (e.g., generate) the AP-CSI report within the default timeline (e.g., the default timeline associated with non-power saving CSI reporting) defined as the later time between a first deadline Z and a second deadline Z′ as illustrated and described in more detail with reference to FIGS. 3 through 5. The first deadline Z may be defined by a last symbol of a physical downlink control channel (PDCCH) carrying the DCI message requesting the CSI report. For example, if the first deadline Z is later than the second deadline Z′, the UE 115-a may transmit the AP-CSI report in a symbol that is no more than Z=12 symbols after the last symbol of the PDCCH carrying the CSI request. The second deadline Z′ may be defined by the end of a CSI-RS. For example, if the second deadline Z′ is later than the first deadline Z, the UE 115-a may transmit the AP-CSI report in a symbol that is no more than Z′=10 symbols after the last symbol of the CSI-RS.

However, such a timeline based on the first deadline Z and the second deadline Z′ (e.g., the default timeline) may assume that (1) the uplink preparation based on the DCI message (e.g., uplink processing) and (2) the CSI-RS signal processing at the UE 115-a (e.g., downlink processing) may be parallelized, which may not be the case for two-part AP-CSI reporting. This may be due to the default timeline for AP-CSI reporting being based on a default timeline for periodic CSI reporting. For example, for periodic CSI reporting, the UE 115-a may begin to generate the CSI report immediately after processing the DCI including the CSI request (e.g., before completion of CSI-RS processing) by assuming rank 1 for rate matching (instead of determining rank information based on the CSI-RS). In this way, a default timeline for periodic CSI reporting may include parallelization of (1) the uplink preparation based on the DCI message (e.g., uplink processing) and (2) the CSI-RS signal processing at the UE 115-a (e.g., downlink processing). Thus, using the latter of the first deadline Z and the second deadline Z′ makes sense for periodic CSI reporting, since the first deadline Z and the second deadline Z′ are parallelized and independent of each other.

However, when an AP-CSI report includes two parts (e.g., a first part and a second part), rate matching for the payload of the CSI report (e.g., in the second part of the two-part AP-CSI report 215) may depend on rank information in the CSI report (e.g., rank information determined from the CSI-RS). In that case, uplink rate matching computation may be serialized after the CSI-RS processing (e.g., instead of parallelized), which may lead to timeline deficiency and power deficiency. In other words, while the first deadline Z and the second deadline Z′ may be the same for periodic CSI reporting and aperiodic CSI reporting, a processing procedure at the UE 115-a may be different (e.g., because periodic CSI reports may be transmitted via PUCCH while AP-CSI reports may be transmitted via PUSCH). The default timeline may not make sense for a two-part AP-CSI report because the second deadline Z′ may be a function of (e.g., dependent on) the first deadline Z. Thus, a relaxed (e.g., adjusted, lengthened) timeline for two-part AP-CSI reporting (e.g., first timeline) on PUSCH may be desired.

In some implementations, the UE 115-a may transmit, to the network entity 105-a, capability signaling 205 indicating a power saving ability of the UE 115-a associated with two-part AP-CSI reporting. For example, the UE 115-a may transmit the capability signaling 205 while in an RRC connection phase. Based on the power saving capability, the wireless devices in the wireless communications system 200 may implement one or more strategies for timeline relaxation for two-part AP-CSI reporting.

In a first strategy, for a UE with the newly defined power saving capability (e.g., the power saving capability indicated by the capability signaling 205), wireless devices in the wireless communications system 200 may relax a timeline requirement of Z/Z′ (e.g., first timeline) for two-part CSI reporting when AP-CSF and AP resources are configured. For example, the UE 115-a may receive, from the network entity 105-a and based on the capability signaling 205, control signaling 210 that both requests the UE 115-a to transmit the two-part AP-CSI report 215 according to a relaxed timeline and provides information about the relaxed timeline. For example, the control signaling 210 may indicate a deadline extension, such as a quantity of symbols in addition to the default timeline (e.g., a quantity of symbols in addition to the first deadline Z, the second deadline Z′, or both) by which the UE is to transmit the two-part AP-CSI report 215. In some examples, the control signaling 210 may directly indicate a value of a deadline extension (e.g., 2 symbols), while in other examples the control signaling 210 may indirectly indicate the relaxed timeline (e.g., by referencing an index in a configured table). The first strategy may be used when the uplink processing and the downlink processing are not independent of each other, and may be illustrated and described in more detail with reference to FIG. 3.

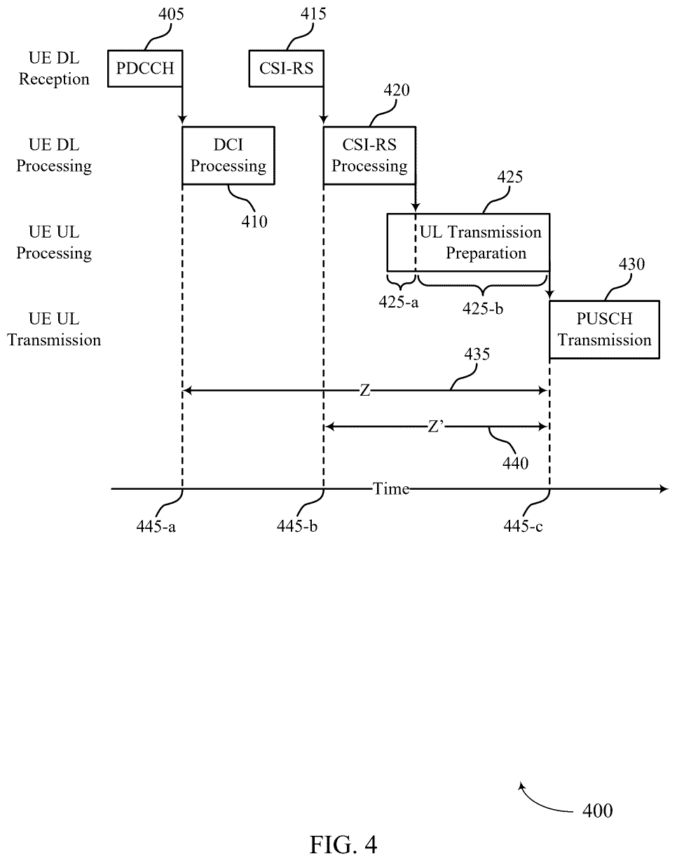

In a second strategy, for a UE with the newly defined power saving capability (e.g., the power saving capability indicated by the capability signaling 205), for the second part (e.g., or a portion of the second part) of a two-part CSI report when AP-CSF and AP resources are configured, wireless devices in the wireless communications system 200 may use puncturing instead of rate matching for the payload of the two-part AP-CSI report 215. That is, based on the capability signaling 205, the UE 115-a may use puncturing instead of rate matching for the payload of the two-part AP-CSI report 215. For example, the UE 115-a may process a first portion of the two-part AP-CSI report before completion of CSI-RS processing, independent of rank information determined from the CSI-RS. In this way, the UE 115-a may partially parallelize the uplink processing and the downlink processing in order to meet a timeline (e.g., the default timeline based on the first deadline Z and the second deadline Z′, the relaxed timeline from the first strategy, or another timeline). The second strategy may be illustrated and described in more detail with reference to FIG. 4.

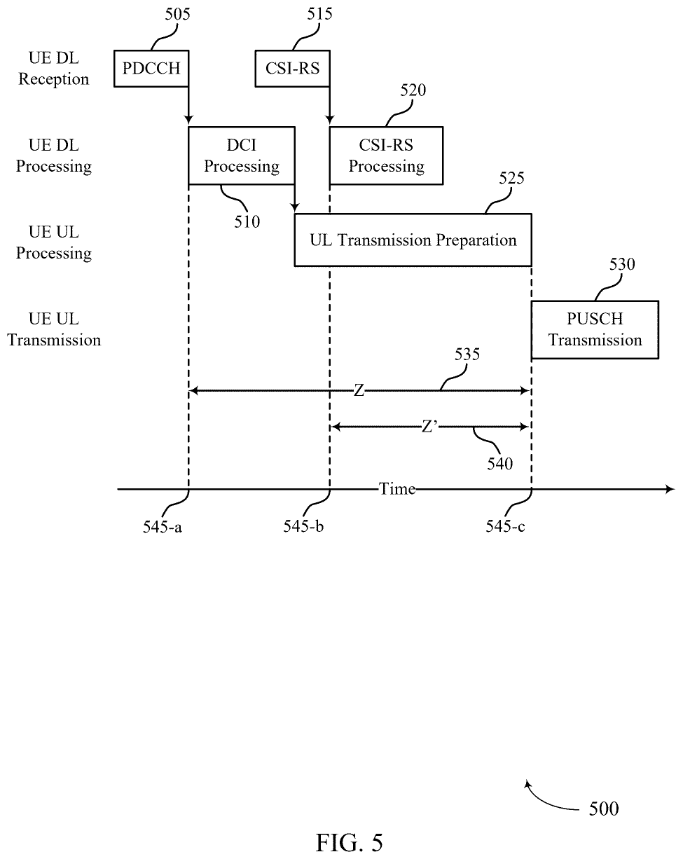

In a third strategy, for a UE with the newly defined power saving capability, wireless devices in the wireless communications system 200 may allow CSI report transmission on PUCCH for a two-part CSI report when AP CSF and AP resources are configured. For example, the UE 115-a may parallelize, based on the capability signaling 205, the downlink processing (e.g., processing of a CSI-RS) and the uplink processing (e.g., processing of one or more CSI-RSs) by assuming rank information (e.g., rank 1) for rate matching a portion of the two-part AP-CSI report 215. Thus, the UE 115-a may transmit the two-part AP-CSI report 215 via PUSCH while retaining the timeline (e.g., based on the first deadline Z and the second deadline Z′) of a periodic CSI report via PUCCH. The third strategy may be illustrated and described in more detail with reference to FIG. 5.

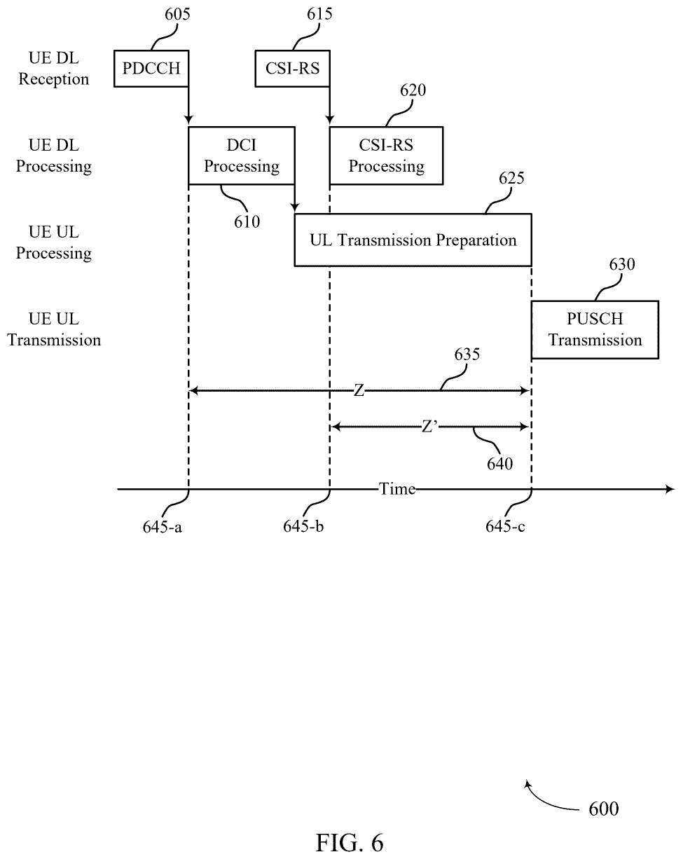

In a fourth strategy, for a UE with the newly defined power saving capability (e.g., the power saving capability indicated by the capability signaling 205), for the second part (e.g., or a portion of the second part) of a two-part CSI report when AP-CSF and AP resources are configured, wireless devices in the wireless communications system 200 may use puncturing instead of rate matching for the payload of the two-part AP-CSI report 215. That is, based on the capability signaling 205, the UE 115-a may use puncturing instead of rate matching for the payload of the two-part AP-CSI report 215. For example, the UE 115-a may process the two-part AP-CSI report before completion of CSI-RS processing, independent of rank information determined from the CSI-RS. In this way, the UE 115-a may parallelize the uplink processing and the downlink processing in order to meet a timeline (e.g., the default timeline based on the first deadline Z and the second deadline Z′, the relaxed timeline from the first strategy, or another timeline). The second strategy may be illustrated and described in more detail with reference to FIG. 6.

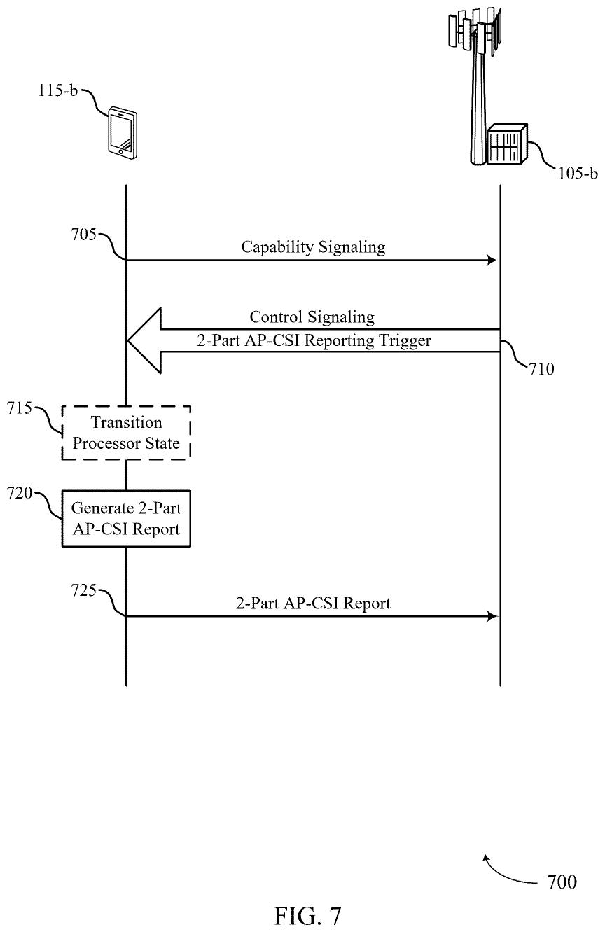

In a fifth strategy, the UE 115-a may bump clock upon DCI reception for a two-part CSI report when AP CSF and AP resources are configured, to meet the default timeline based on the first deadline Z and the second deadline Z′ (e.g., a default timeline defined in a standards specification). For example, the UE 115-a may switch from a first processor state associated with a first processing speed to a second processor state associated with a second processing speed (e.g., where the second processing speed is faster than the first processing speed) to generate the two-part AP-CSI report 215 within the default timeline defined by the first deadline Z and the second deadline Z′. The fifth strategy may be illustrated and described in more detail with reference to FIG. 7, including step 715.

Relaxing the timeline for two-part AP-CSI reporting (e.g., via any of the first strategy, the second strategy, the third strategy, and the fifth strategy) may allow the UE 115-a to save power. For example, the UE 115-a may enter a processor unit state associated with a relatively fast processing speed and a relatively high power consumption to meet the default timeline. By relaxing the timeline, the UE 115-a may expend fewer resources (e.g., enter a processor unit state associated with a slower processing speed and lower power consumption) to prepare and transmit a two-part AP-CSI report.

FIG. 3 shows an example of a timing diagram 300 that supports relaxed timeline for AP-CSI reporting on an uplink shared channel in accordance with one or more aspects of the present disclosure. The timing diagram 300 may implement or be implemented by one or more aspects of the wireless communications system 100 and the wireless communications system 200 described with reference to FIGS. 1 and 2, respectively. For example, the timing diagram 300 may be implemented by a network entity 105 and a UE 115 as described with reference to FIGS. 1 and 2 to support a relaxed timeline for two-part AP-CSI reporting.

For example, the timing diagram 300 illustrates a UE 115 receiving a PDCCH 305 including control signaling (e.g., a DCI message) requesting the UE 115 to transmit a two-part AP-CSI report via a PUSCH transmission 330 in accordance with a relaxed timeline (e.g., UE downlink reception). At a first time 345-a, the UE 115 may complete reception of the PDCCH 305 and may begin DCI processing 310 (e.g., UE downlink processing). The UE 115 may then receive a CSI-RS 315 that provides the UE 115 with channel information. At a second time 345-b, the UE 115 may complete reception of the CSI-RS 315 and may begin CSI-RS processing 320. After completion of the CSI-RS processing 320, the UE 115 may begin uplink transmission preparation 325 (e.g., UE uplink processing, in which the UE 115 generates at least a portion of a two-part AP-CSI report in accordance with a relaxed timeline indicated by the PDCCH 305). In some examples, the uplink transmission preparation 325 may include generating the second part of the two-part AP-CSI report. At the completion of the uplink transmission preparation 325, the UE 115 may transmit, to a network entity 105, the PUSCH transmission 330 including the two-part AP-CSI report.

A default timeline for AP-CSI reporting may be defined as the later time between a first deadline Z 335 and a second deadline Z′340. The first deadline Z 335 may be defined by a last symbol of the PDCCH 305 carrying the DCI message requesting the CSI report. That is, Z may be defined as a quantity of symbols (e.g., 12 symbols) after the first time 345-a by which the UE is to begin sending the PUSCH transmission 330. For example, if the first deadline Z 335 is later than the second deadline Z′ 340, the UE 115 may transmit the AP-CSI report (e.g., the PUSCH transmission 330) in a symbol (e.g., at a third time 345-c) that is no more than Z=12 symbols after the last symbol of the PDCCH 305 carrying the CSI request (e.g., the first time 345-a). The second deadline Z′ 340 may be defined by a quantity of symbols (e.g., 10 symbols) after the end of a CSI-RS 315 (e.g., at the second time 345-b). For example, if the second deadline Z′ 340 is later than the first deadline Z 335, the UE 115 may transmit the AP-CSI report (e.g., the PUSCH transmission 330) in a symbol (e.g., the third time 345-c) that is no more than Z′=10 symbols after the last symbol of the CSI-RS 315 (e.g., after the second time 345-b). While the example illustrated by the timing diagram 300 shows the first deadline Z 335 and the second deadline Z′ 340 indicating the UE 115 to transmit the PUSCH transmission 330 by a same time (e.g., the third time 345-c), other examples may have the first deadline Z 335 and the second deadline Z′ 340 indicating different times for the UE 115 to transmit the PUSCH transmission 330, in which case the UE 115 may transmit the PUSCH transmission 330 according to the later of the two times.

In contrast, the timing diagram 300 illustrates a relaxed timeline for AP-CSI reporting that may include one or more additional symbols before the UE 115 is to transmit the PUSCH transmission 330 including the two-part AP-CSI report. For example, the PDCCH 305 (e.g., the control signaling, the DCI message) may include information about the relaxed timeline, such as information indicating a deadline extension 350. The deadline extension 350 may be a quantity of symbols X in addition to the default timeline (e.g., a quantity of symbols in addition to the first deadline Z 335, the second deadline Z′ 340, or both) by which the UE 115 is to transmit the two-part AP-CSI report 215. For an example where X =2 symbols, instead of transmitting the PUSCH transmission 330 at the third time 345-c that is Z=12 symbols after the first time 345-a, the UE 115 may transmit the PUSCH transmission 330 at a fourth time 345-d that is Z+X=12+2=14 symbols after receiving the PDCCH 305 at the first time 345-a. In a similar example, instead of transmitting the PUSCH transmission 330 at the third time 345-c that is Z′=10 symbols after the second time 345-b, the UE 115 may transmit the PUSCH transmission 330 at a fourth time 345-d that is Z′+X=10+2=12 symbols after receiving the CSI-RS 315 at the second time 345-b. In this way, the UE 115 may transmit the two-part AP-CSI report via the PUSCH transmission 330 according to a relaxed timeline indicated by the PDCCH 305. In some examples, the deadline extension 350 may be initially configured at the UE 115 (e.g., based on a standard).

FIG. 4 shows an example of a timing diagram 400 that supports relaxed timeline for AP-CSI reporting on an uplink shared channel in accordance with one or more aspects of the present disclosure. The timing diagram 400 may implement or be implemented by one or more aspects of the wireless communications system 100 and the wireless communications system 200 described with reference to FIGS. 1 and 2, respectively. For example, the timing diagram 400 may be implemented by a network entity 105 and a UE 115 as described with reference to FIGS. 1 and 2 to support a relaxed timeline for two-part AP-CSI reporting.

For example, the timing diagram 400 illustrates a UE 115 receiving a PDCCH 405 including control signaling (e.g., a DCI message) requesting the UE 115 to transmit a two-part AP-CSI report via a PUSCH transmission 430 in accordance with a relaxed timeline (e.g., UE downlink reception). At a first time 445-a, the UE 115 may complete reception of the PDCCH 405 and may begin DCI processing 410 (e.g., UE downlink processing). The UE 115 may then receive a CSI-RS 415 that provides the UE 115 with channel information. At a second time 445-b, the UE 115 may complete reception of the CSI-RS 415 and may begin CSI-RS processing 420. After completion of the CSI-RS processing 420, the UE 115 may begin uplink transmission preparation 425 (e.g., UE uplink processing, in which the UE 115 generates a two-part AP-CSI report in accordance with a relaxed timeline indicated by the PDCCH 405). At the completion of the uplink transmission preparation 425, the UE 115 may transmit, to a network entity 105, the PUSCH transmission 430 including the two-part AP-CSI report.

A default timeline for AP-CSI reporting may be defined as the later time between a first deadline Z 435 and a second deadline Z′ 440. The first deadline Z 435 may be defined by a last symbol of the PDCCH 405 carrying the DCI message requesting the CSI report. That is, Z may be defined as a quantity of symbols (e.g., 12 symbols) after the first time 445-a by which the UE is to begin sending the PUSCH transmission 430. For example, if the first deadline Z 435 is later than the second deadline Z′ 440, the UE 115 may transmit the AP-CSI report (e.g., the PUSCH transmission 430) in a symbol (e.g., at a third time 445-c) that is no more than Z=12 symbols after the last symbol of the PDCCH 405 carrying the CSI request (e.g., the first time 445-a). The second deadline Z′ 440 may be defined by a quantity of symbols (e.g., 10 symbols) after the end of a CSI-RS 415 (e.g., at the second time 445-b). For example, if the second deadline Z′ 440 is later than the first deadline Z 435, the UE 115 may transmit the AP-CSI report (e.g., the PUSCH transmission 430) in a symbol (e.g., the third time 445-c) that is no more than Z′=10 symbols after the last symbol of the CSI-RS 415 (e.g., after the second time 445-b). While the example illustrated by the timing diagram 400 shows the first deadline Z 435 and the second deadline Z′ 440 indicating the UE 115 to transmit the PUSCH transmission 430 by a same time (e.g., the third time 445-c), other examples may have the first deadline Z 435 and the second deadline Z′ 440 indicating different times for the UE 115 to transmit the PUSCH transmission 430, in which case the UE 115 may transmit the PUSCH transmission 430 according to the later of the two times.

In a second strategy (e.g., a UE-specific implementation, where the first strategy is described with reference to FIG. 3 and a third strategy is described with reference to FIG. 5), for a UE with a newly defined power saving capability, for the second part (e.g., or a portion of the second part) of a two-part CSI report when AP-CSF and AP resources are configured, a UE may use puncturing instead of rate matching for the payload of the two-part AP-CSI report. That is, the UE 115 may use puncturing instead of rate matching for the payload of the PUSCH transmission 430. For example, the uplink transmission preparation 425 may be divided into a first uplink transmission preparation 425-a and a second uplink transmission preparation 425-b. The first uplink transmission preparation 425-a (e.g., preparation of a first portion of the two-part AP-CSI report) may not depend on the CSI-RS processing 420, while the second uplink transmission preparation 425-b (e.g., preparation of a second portion of the two-part AP-CSI report0 may still depend on the CSI-RS processing 420. In some examples, the second uplink transmission preparation 425-b may be a smaller portion of the uplink transmission preparation 425 than the first uplink transmission preparation 425-a (e.g., different than illustrated by FIG. 4). In order to meet a deadline for the PUSCH transmission 430 (e.g., based on the default timeline or a relaxed timeline), the UE 115 may process a first portion of the two-part AP-CSI report before completion of CSI-RS processing, independent of rank information determined from the CSI-RS. That is, the UE 115 may perform the first uplink transmission preparation 425-a before completing the CSI-RS processing 420, and may perform the second uplink transmission preparation 425-b after completing the CSI-RS processing 420. By beginning the uplink transmission preparation 425 early, the UE 115-a may partially parallelize the uplink processing and the downlink processing in order to meet a timeline (e.g., the default timeline based on the first deadline Z 435 and the second deadline Z′ 440, the relaxed timeline from the first strategy described with reference to FIG. 3, or another timeline).

FIG. 5 shows an example of a timing diagram 500 that supports relaxed timeline for AP-CSI reporting on an uplink shared channel in accordance with one or more aspects of the present disclosure. The timing diagram 500 may implement or be implemented by one or more aspects of the wireless communications system 100 and the wireless communications system 200 described with reference to FIGS. 1 and 2, respectively. For example, the timing diagram 500 may be implemented by a network entity 105 and a UE 115 as described with reference to FIGS. 1 and 2 to support a relaxed timeline for two-part AP-CSI reporting.

For example, the timing diagram 500 illustrates a UE 115 receiving a PDCCH 505 including control signaling (e.g., a DCI message) requesting the UE 115 to transmit a two-part AP-CSI report via a PUSCH transmission 530 in accordance with a relaxed timeline (e.g., UE downlink reception). At a first time 545-a, the UE 115 may complete reception of the PDCCH 505 and may begin DCI processing 510 (e.g., UE downlink processing). The UE 115 may then receive a CSI-RS 515 that provides the UE 115 with channel information. At a second time 545-b, the UE 115 may complete reception of the CSI-RS 515 and may begin CSI-RS processing 520. After completion of the DCI processing 510, the UE 115 may begin uplink transmission preparation 525 (e.g., UE uplink processing, in which the UE 115 generates a two-part AP-CSI report in accordance with a relaxed timeline indicated by the PDCCH 505). At the completion of the uplink transmission preparation 525 at a third time 545-c, the UE 115 may transmit, to a network entity 105, the PUSCH transmission 530 including the two-part AP-CSI report.

A default timeline for AP-CSI reporting may be defined as the later time between a first deadline Z 535 and a second deadline Z′ 540. The first deadline Z 535 may be defined by a last symbol of the PDCCH 505 carrying the DCI message requesting the CSI report. That is, Z may be defined as a quantity of symbols (e.g., 12 symbols) after the first time 545-a by which the UE is to begin sending the PUSCH transmission 530. For example, if the first deadline Z 535 is later than the second deadline Z′ 540, the UE 115 may transmit the AP-CSI report (e.g., the PUSCH transmission 530) in a symbol (e.g., at a third time 545-c) that is no more than Z=12 symbols after the last symbol of the PDCCH 505 carrying the CSI request (e.g., the first time 545-a). The second deadline Z′ 540 may be defined by a quantity of symbols (e.g., 10 symbols) after the end of a CSI-RS 515 (e.g., at the second time 545-b). For example, if the second deadline Z′ 540 is later than the first deadline Z 535, the UE 115 may transmit the AP-CSI report (e.g., the PUSCH transmission 530) in a symbol (e.g., the third time 545-c) that is no more than Z′=10 symbols after the last symbol of the CSI-RS 515 (e.g., after the second time 545-b). While the example illustrated by the timing diagram 500 shows the first deadline Z 535 and the second deadline Z′ 540 indicating the UE 115 to transmit the PUSCH transmission 530 by a same time (e.g., the third time 545-c), other examples may have the first deadline Z 535 and the second deadline Z′ 540 indicating different times for the UE 115 to transmit the PUSCH transmission 530, in which case the UE 115 may transmit the PUSCH transmission 530 according to the later of the two times.

In a third strategy (e.g., where a first strategy is described with reference to FIG. 3, the second strategy is described with reference to FIG. 4, and a fourth strategy is described with reference to FIG. 6), for a UE with a newly defined power saving capability, the UE may allow CSI report transmission on PUCCH for a two-part CSI report when AP CSF and AP resources are configured. That is, a UE 115 may perform the uplink transmission preparation 525 for the PUSCH transmission 530 of a two-part AP-CSI report in a way similar to uplink transmission preparation for a periodic CSI report on PUCCH. For example, the UE 115 may parallelize, based on a power-saving capability of the UE 115, the downlink processing (e.g., the CSI-RS processing 520) and the uplink processing (e.g., the uplink transmission preparation 525) by assuming rank information for rate matching a portion of the two-part AP-CSI report to be included in the PUSCH transmission 530. For example, the UE 115 may begin the uplink transmission preparation 525 before completing the CSI-RS processing 520 by assuming rank 1 for the PUSCH transmission 530. Thus, the UE 115 may transmit the two-part AP-CSI report via the PUSCH transmission 530 while retaining a default timeline (e.g., based on the first deadline Z 535 and the second deadline Z′ 540) of a periodic CSI report via a PUCCH transmission.

FIG. 6 shows an example of a timing diagram 600 that supports relaxed timeline for AP-CSI reporting on an uplink shared channel in accordance with one or more aspects of the present disclosure. In some examples, the timing diagram 600 may be implemented by, or may implement aspects of, the wireless communications systems 100 and 200 and the timing diagrams 300, 400, and 500. For example, the timing diagram 500 may be implemented by a network entity 105 and a UE 115 as described with reference to FIGS. 1 and 2 to support a relaxed timeline for two-part AP-CSI reporting.

For example, the timing diagram 600 illustrates a UE 115 receiving a PDCCH 605 including control signaling (e.g., a DCI message) requesting the UE 115 to transmit a two-part AP-CSI report via a PUSCH transmission 630 in accordance with a relaxed timeline (e.g., UE downlink reception). At a first time 645-a, the UE 115 may complete reception of the PDCCH 605 and may begin DCI processing 610 (e.g., UE downlink processing). The UE 115 may then receive a CSI-RS 615 that provides the UE 115 with channel information. At a second time 645-b, the UE 115 may complete reception of the CSI-RS 615 and may begin CSI-RS processing 620. After completion of the CSI-RS processing 620, the UE 115 may begin uplink transmission preparation 625 (e.g., UE uplink processing, in which the UE 115 generates a two-part AP-CSI report in accordance with a relaxed timeline indicated by the PDCCH 605). At the completion of the uplink transmission preparation 625, the UE 115 may transmit, to a network entity 105, the PUSCH transmission 630 including the two-part AP-CSI report.

A default timeline for AP-CSI reporting may be defined as the later time between a first deadline Z 635 and a second deadline Z′ 640. The first deadline Z 635 may be defined by a last symbol of the PDCCH 605 carrying the DCI message requesting the CSI report. That is, Z may be defined as a quantity of symbols (e.g., 12 symbols) after the first time 645-a by which the UE is to begin sending the PUSCH transmission 630. For example, if the first deadline Z 635 is later than the second deadline Z′ 640, the UE 115 may transmit the AP-CSI report (e.g., the PUSCH transmission 630) in a symbol (e.g., at a third time 645-c) that is no more than Z=12 symbols after the last symbol of the PDCCH 605 carrying the CSI request (e.g., the first time 645-a). The second deadline Z′ 640 may be defined by a quantity of symbols (e.g., 10 symbols) after the end of a CSI-RS 615 (e.g., at the second time 645-b). For example, if the second deadline Z′ 640 is later than the first deadline Z 635, the UE 115 may transmit the AP-CSI report (e.g., the PUSCH transmission 630) in a symbol (e.g., the third time 645-c) that is no more than Z′=10 symbols after the last symbol of the CSI-RS 615 (e.g., after the second time 645-b). While the example illustrated by the timing diagram 600 shows the first deadline Z 635 and the second deadline Z′ 640 indicating the UE 115 to transmit the PUSCH transmission 630 by a same time (e.g., the third time 645-c), other examples may have the first deadline Z 635 and the second deadline Z′ 640 indicating different times for the UE 115 to transmit the PUSCH transmission 630, in which case the UE 115 may transmit the PUSCH transmission 630 according to the later of the two times.

In a fourth strategy (e.g., a UE-specific implementation, where the first strategy is described with reference to FIG. 3, the second strategy is described with reference to FIG. 4, and the third strategy is described with reference to FIG. 5), for a UE with a newly defined power saving capability, for the second part (e.g., or a portion of the second part) of a two-part CSI report when AP-CSF and AP resources are configured, a UE may use puncturing instead of rate matching for the payload of the two-part AP-CSI report. That is, the UE 115 may use puncturing instead of rate matching for the payload of the PUSCH transmission 630. That is, in order to meet a deadline for the PUSCH transmission 630 (e.g., based on the default timeline or a relaxed timeline), the UE 115 may perform the uplink transmission preparation 625 before completing the CSI-RS processing 620. By beginning the uplink transmission preparation 625 early, the UE 115-a may parallelize the uplink processing and the downlink processing in order to meet a timeline (e.g., the default timeline based on the first deadline Z 635 and the second deadline Z′ 640, the relaxed timeline from the first strategy described with reference to FIG. 3, or another timeline).

In some examples, the UE 115 may parallelize, based on a power-saving capability of the UE 115, the downlink processing (e.g., the CSI-RS processing 620) and the uplink processing (e.g., the uplink transmission preparation 625) by applying puncturing of the payload of the PUSCH transmission 630. For example, the UE 115 may begin the uplink transmission preparation 625 before completing the CSI-RS processing 620 by performing a puncturing of the PUSCH transmission 630. Thus, the UE 115 may transmit the two-part AP-CSI report via the PUSCH transmission 630 while retaining a default timeline (e.g., based on the first deadline Z 635 and the second deadline Z′ 640) of a periodic CSI report via a PUCCH transmission.

FIG. 7 shows an example of a process flow 700 that supports relaxed timeline for AP-CSI reporting on an uplink shared channel in accordance with one or more aspects of the present disclosure. In some examples, the process flow 700 may be implemented by, or may implement aspects of, the wireless communications systems 100 and 200 and the timing diagrams 300, 400, 500, and 600. For example, the process flow 700 includes a network entity 105-b and a UE 115-b, which may be examples of the corresponding devices described with reference to FIGS. 1 and 2. Following the process flow 700, the UE 115-b may transmit a two-part AP-CSI report within a relaxed timeline. Alternative examples of the following may be implemented, where some steps are performed in a different order than described or are not performed at all. In some cases, steps may include additional features not mentioned below, or further steps may be added. Although the UE 115-b and the network entity 105-b are shown performing the operations of the process flow 700, some aspects of some operations may also be performed by one or more other wireless devices.

At 705, the UE 115-a may transmit, and the network entity 105-b may receive or obtain, capability signaling indicating a power saving capability of the UE. The power saving capability may be associated with two-part CSI reporting (e.g., AP-CSI reporting). For example, the capability signaling may indicate, to the network entity 105-b, that the UE 115-b is capable of processing a two-part AP-CSI report for transmission via a PUSCH within a relaxed timeline.

At 710, the network entity 105-b may output or transmit, and the UE 115-b may receive based on the capability signaling at 705, control signaling. The control signaling may include information triggering two-part AP-CSI reporting. For example, a two-part AP-CSI report may include a first part and a second part. The first part of the two-part CSI report may include at least in indication of a quantity (e.g., a number) of information bits associated with the second part of the two-part CSI report. The second part of the two-part CSI report may include at least a precoding matric indicator and a quantity of bits indicated by the first part of the CSI report. In some examples, the information in the control signaling may indicate a relaxed timeline for the generation and processing of a two-part power-saving AP-CSI report that differs from a default timeline associated with non-power saving CSI reporting. For example, the default timeline associated with non-power saving CSI reporting may be based on a later of a first deadline Z and a second deadline Z′ (e.g., as illustrated by FIGS. 3 through 5). The first deadline Z may be defined as a quantity of symbols after a last symbol of the control signaling at 710 (e.g., the last symbol of a PDCCH carrying a DCI message requesting the two part AP-CSI report). The second deadline Z′ may be defined as a quantity of symbols after the end of a CSI-RS.

In some examples, the information in the control signaling may indicate a quantity of symbols of the relaxed timeline, which may be greater than a quantity of symbols of the default timeline (e.g., the first deadline Z and the second deadline Z′) associated with non-power saving CSI reporting. For example, the control signaling may indicate an absolute quantity of symbols of the relaxed timeline (e.g., 12 symbols, compared to 10 symbols indicated by the first deadline Z). In another example, the control signaling may indicate a relative quantity of symbols X (e.g., 2 symbols more than the timeline indicated by the first deadline Z and the second deadline Z′, so that the total quantity of symbols is Z +X or Z′+X=10+2=12 symbols).

In some examples, the UE 115-b may receive the control signaling while in a first processing unit state (e.g., a relatively slow processing unit state) associated with a first processing speed.

At 715, the UE 115-b may transition, based on the control signaling, from the first processing unit state to a second processing unit state associated with a second processing speed (e.g., the UE 115-b may bump clock). The second processing speed may be faster than the first processing speed. For example, a CPU of the UE 115-b may transition from a relatively slow CPU state to a relatively fast CPU state. In another example, the UE 115-b may use different hardware architecture to process the two-part AP-CSI report, and transitioning from the first processing unit state to a second processing unit state may apply to any processing unit with different levels of processing speed. Thus, the UE 115-b may transition to a faster processor state in order to process or generate the at least part of the two-part CSI report within the timeline specified by the control signaling at 710. In this way, the UE 115-b may limit power consumption. In some examples, the transition may be based on the capability signaling at 705, while in other examples, the transition may be independent of the capability signaling at 705.

At 720, the UE 115-b may generate at least a part of a two-part CSI report (e.g., the first part of the two-part CSI report, the second part of the two-part CSI report, a portion of the first part of the two-part CSI report, a portion of the second part of the two-part CSI report, or a combination thereof). In some examples, the generating may be based on the capability signaling and may be in accordance with the timeline indicated by the control signaling at 710 (e.g., the relaxed timeline greater than the default timeline). In some examples, generating the two-part CSI report may include processing a first portion of the two-part CSI report (e.g., a first portion of the second part of the two-part CSI report) at a time prior to processing a second portion of the two-part CSI report (e.g., as described in more detail with reference to FIG. 4). For example, the UE 115-b may process the first portion of the two part CSI report independent of rank information associated with a CSI-RS and may process the second portion of the two-part CSI report based on the rank information associated with the CSI-RS (e.g., after receiving and processing one or more CSI-RSs). That is, the UE 115-b may puncture a payload of the two-part CSI report (e.g., rather than rate matching).

In some examples, the timeline may be based on the control signaling at 710, based on static configuration information (e.g., as defined in a standard), or based on both. In some examples, the UE 115-b may generate the at least part of the two-part CSI report while in the second processing unit state associated with the faster processing speed (e.g., in order to meet the timeline indicated by the control signaling at 710).

At 725, the UE 115-b may transmit at least the part of the two-part CSI report (e.g., the first part of the two-part CSI report, the second part of the two-part CSI report, the portion of the first part of the two-part CSI report, the portion of the second part of the two-part CSI report, or the combination thereof) via a PUSCH in accordance with the timeline (e.g., the relaxed timeline). In some examples, the UE 115-b may transmit at least the part of the two-part CSI report via PUSCH using an assumed rank for a portion of the two-part CSI report (e.g., similar to a CSI report transmitted in PUCCH). This may allow the UE 115-b to begin processing or generating the two-part CSI report earlier than in a non-power saving example, in which the UE 115-b completes processing of a CSI-RS to determine rank information to use in generating a CSI report. For example, the uplink transmission preparation (e.g., generating the two-part CSI report) may be parallelized with the downlink processing of a CSI-RS.

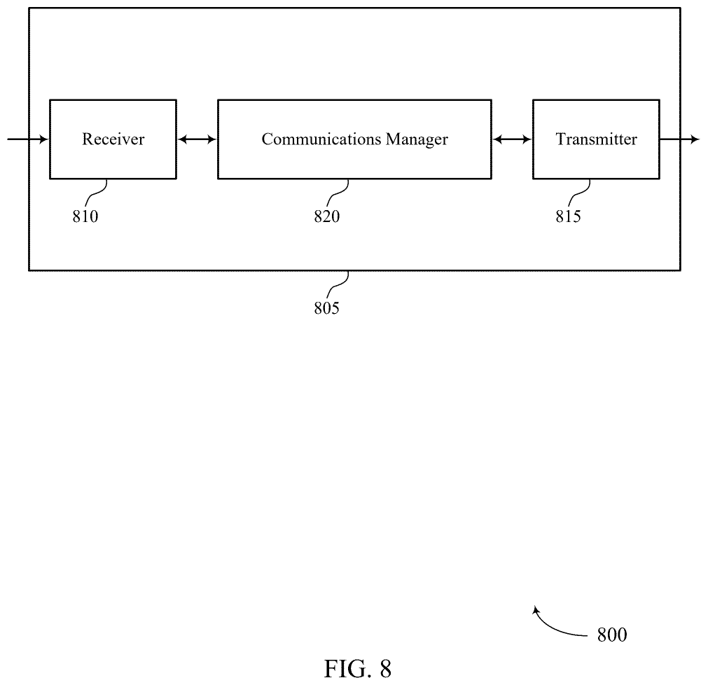

FIG. 8 shows a block diagram 800 of a device 805 that supports relaxed timeline for AP-CSI reporting on an uplink shared channel in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to relaxed timeline for aperiodic channel state information reporting on an uplink shared channel). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to relaxed timeline for aperiodic channel state information reporting on an uplink shared channel). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of relaxed timeline for aperiodic channel state information reporting on an uplink shared channel as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for transmitting capability signaling indicating a power saving capability associated with two-part channel state information reporting. The communications manager 820 is capable of, configured to, or operable to support a means for receiving, based on the capability signaling, control signaling including information triggering aperiodic two-part channel state information reporting. The communications manager 820 is capable of, configured to, or operable to support a means for generating, based on the capability signaling, at least a part of a two-part channel state information report in accordance with a timeline that is in accordance with the control signaling, where the timeline differs from a default timeline associated with non-power saving channel state information reporting. The communications manager 820 is capable of, configured to, or operable to support a means for transmitting at least the part of the two-part channel state information report via an uplink shared channel in accordance with the timeline.

Additionally, or alternatively, the communications manager 820 may support wireless communications in accordance with examples as disclosed herein. For example, the communications manager 820 is capable of, configured to, or operable to support a means for receiving, while in a first processing unit state associated with a first processing speed, control signaling triggering aperiodic two-part channel state information reporting, where the control signaling instructs the UE to generate a two-part channel state information report within a timeline. The communications manager 820 is capable of, configured to, or operable to support a means for transitioning, based on the control signaling, from the first processing unit state to a second processing unit state associated with a second processing speed, the second processing speed faster than the first processing speed. The communications manager 820 is capable of, configured to, or operable to support a means for generating, based on the control signaling and while in the second processing unit state, at least a part of the two-part channel state information report within the timeline. The communications manager 820 is capable of, configured to, or operable to support a means for transmitting at least the part of the two-part channel state information report via an uplink shared channel.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced power consumption and more efficient utilization of communication resources.

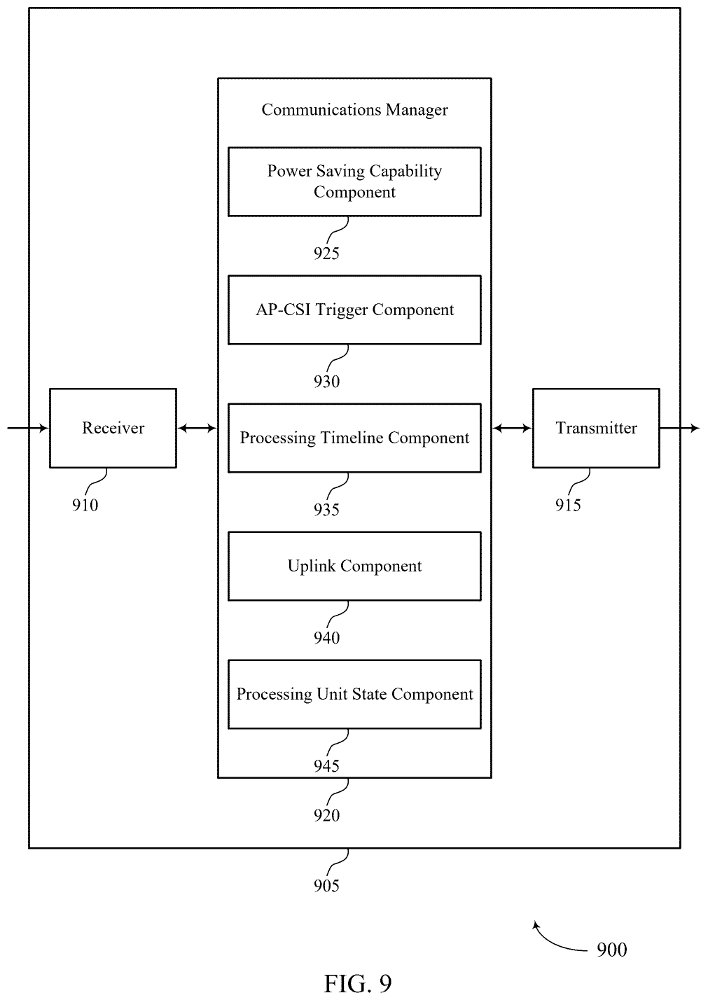

FIG. 9 shows a block diagram 900 of a device 905 that supports relaxed timeline for aperiodic channel state information reporting on an uplink shared channel in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to relaxed timeline for aperiodic channel state information reporting on an uplink shared channel). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to relaxed timeline for aperiodic channel state information reporting on an uplink shared channel). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of relaxed timeline for aperiodic channel state information reporting on an uplink shared channel as described herein. For example, the communications manager 920 may include a power saving capability component 925, an AP-CSI trigger component 930, a processing timeline component 935, an uplink component 940, a processing unit state component 945, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The power saving capability component 925 is capable of, configured to, or operable to support a means for transmitting capability signaling indicating a power saving capability associated with two-part channel state information reporting. The AP-CSI trigger component 930 is capable of, configured to, or operable to support a means for receiving, based on the capability signaling, control signaling including information triggering aperiodic two-part channel state information reporting. The processing timeline component 935 is capable of, configured to, or operable to support a means for generating, based on the capability signaling, at least a part of a two-part channel state information report in accordance with a timeline that is in accordance with the control signaling, where the timeline differs from a default timeline associated with non-power saving channel state information reporting. The uplink component 940 is capable of, configured to, or operable to support a means for transmitting at least the part of the two-part channel state information report via an uplink shared channel in accordance with the timeline.

Additionally, or alternatively, the communications manager 920 may support wireless communications in accordance with examples as disclosed herein. The AP-CSI trigger component 930 is capable of, configured to, or operable to support a means for receiving, while in a first processing unit state associated with a first processing speed, control signaling triggering aperiodic two-part channel state information reporting, where the control signaling instructs the UE to generate a two-part channel state information report within a timeline. The processing unit state component 945 is capable of, configured to, or operable to support a means for transitioning, based on the control signaling, from the first processing unit state to a second processing unit state associated with a second processing speed, the second processing speed faster than the first processing speed. The processing unit state component 945 is capable of, configured to, or operable to support a means for generating, based on the control signaling and while in the second processing unit state, at least a part of the two-part channel state information report within the timeline. The uplink component 940 is capable of, configured to, or operable to support a means for transmitting at least the part of the two-part channel state information report via an uplink shared channel.

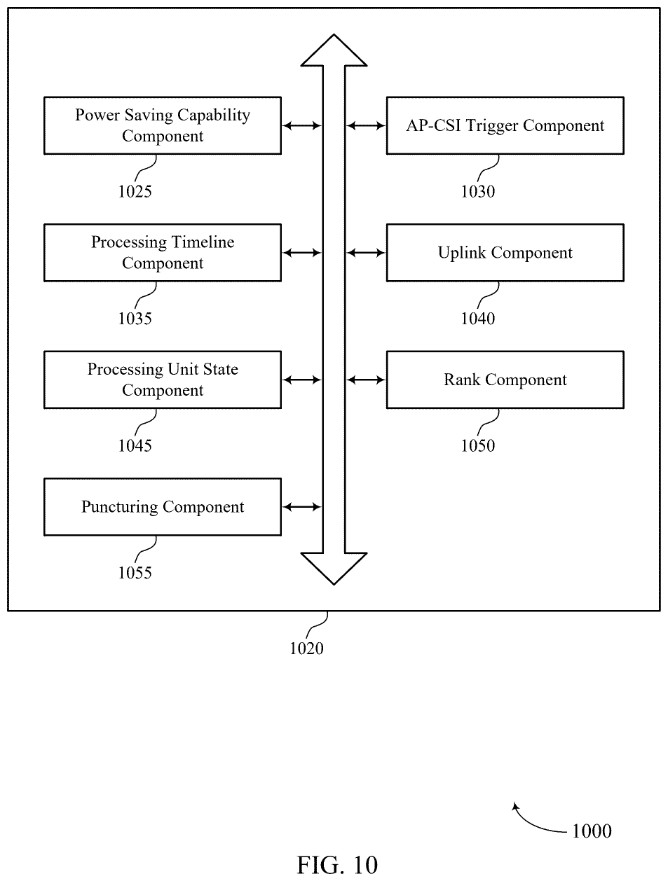

FIG. 10 shows a block diagram 1000 of a communications manager 1020 that supports relaxed timeline for aperiodic channel state information reporting on an uplink shared channel in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of relaxed timeline for aperiodic channel state information reporting on an uplink shared channel as described herein. For example, the communications manager 1020 may include a power saving capability component 1025, an AP-CSI trigger component 1030, a processing timeline component 1035, an uplink component 1040, a processing unit state component 1045, a rank component 1050, a puncturing component 1055, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The power saving capability component 1025 is capable of, configured to, or operable to support a means for transmitting capability signaling indicating a power saving capability associated with two-part channel state information reporting. The AP-CSI trigger component 1030 is capable of, configured to, or operable to support a means for receiving, based on the capability signaling, control signaling including information triggering aperiodic two-part channel state information reporting. The processing timeline component 1035 is capable of, configured to, or operable to support a means for generating, based on the capability signaling, at least a part of a two-part channel state information report in accordance with a timeline that is in accordance with the control signaling, where the timeline differs from a default timeline associated with non-power saving channel state information reporting. The uplink component 1040 is capable of, configured to, or operable to support a means for transmitting at least the part of the two-part channel state information report via an uplink shared channel in accordance with the timeline.

In some examples, to support receiving the control signaling, the processing timeline component 1035 is capable of, configured to, or operable to support a means for receiving an indication of a quantity of symbols of the timeline, where the quantity of symbols of the timeline is greater than a quantity of symbols of the default timeline associated with non-power saving channel state information reporting.

In some examples, the indication of the quantity of symbols of the timeline includes an additional quantity of symbols relative to the quantity of symbols of the default timeline.

In some examples, to support generating at least the part of the two-part channel state information report, the processing timeline component 1035 is capable of, configured to, or operable to support a means for processing a first portion of the two-part channel state information report prior to starting a processing of a second portion of the two-part channel state information report, where processing the first portion of the two-part channel state information report is independent of rank information associated with one or more channel state information reference signals. In some examples, to support generating at least the part of the two-part channel state information report, the processing timeline component 1035 is capable of, configured to, or operable to support a means for processing the second portion of the two-part channel state information report based on the rank information associated with the one or more channel state information reference signals.

In some examples, to support generating at least the part of the two-part channel state information report, the puncturing component 1055 is capable of, configured to, or operable to support a means for puncturing a payload of the two-part channel state information report.

In some examples, to support transmitting at least the part of the two-part channel state information report, the rank component 1050 is capable of, configured to, or operable to support a means for transmitting, based on the power saving capability, at least the part of the two-part channel state information report using an assumed rank for a portion of the two-part channel state information report.

In some examples, the timeline is based on a quantity of symbols after receiving the control signaling, a quantity of symbols after receiving a channel state information reference signal, or both.

In some examples, the timeline is based on the control signaling, based on static configuration information, or a combination thereof.

In some examples, the part of the two-part channel state information report includes a second part of the two-part channel state information report. In some examples, the second part of the two-part channel state information report includes at least a precoding matrix indicator. In some examples, a first part of the two-part channel state information report includes at least an indication of a number (e.g., a quantity) of information bits associated with the second part of the two-part channel state information report.

Additionally, or alternatively, the communications manager 1020 may support wireless communications in accordance with examples as disclosed herein. In some examples, the AP-CSI trigger component 1030 is capable of, configured to, or operable to support a means for receiving, while in a first processing unit state associated with a first processing speed, control signaling triggering aperiodic two-part channel state information reporting, where the control signaling instructs the UE to generate a two-part channel state information report within a timeline. The processing unit state component 1045 is capable of, configured to, or operable to support a means for transitioning, based on the control signaling, from the first processing unit state to a second processing unit state associated with a second processing speed, the second processing speed faster than the first processing speed. In some examples, the processing unit state component 1045 is capable of, configured to, or operable to support a means for generating, based on the control signaling and while in the second processing unit state, at least a part of the two-part channel state information report within the timeline. In some examples, the uplink component 1040 is capable of, configured to, or operable to support a means for transmitting at least the part of the two-part channel state information report via an uplink shared channel.

In some examples, the timeline is based on a quantity of symbols after receiving the control signaling, a quantity of symbols after receiving a channel state information reference signal, or both.

In some examples, the part of the two-part channel state information report includes a second part of the two-part channel state information report. In some examples, the second part of the two-part channel state information report includes at least a precoding matrix indicator. In some examples, a first part of the two-part channel state information report includes at least an indication of a number of information bits associated with the second part of the two-part channel state information report.

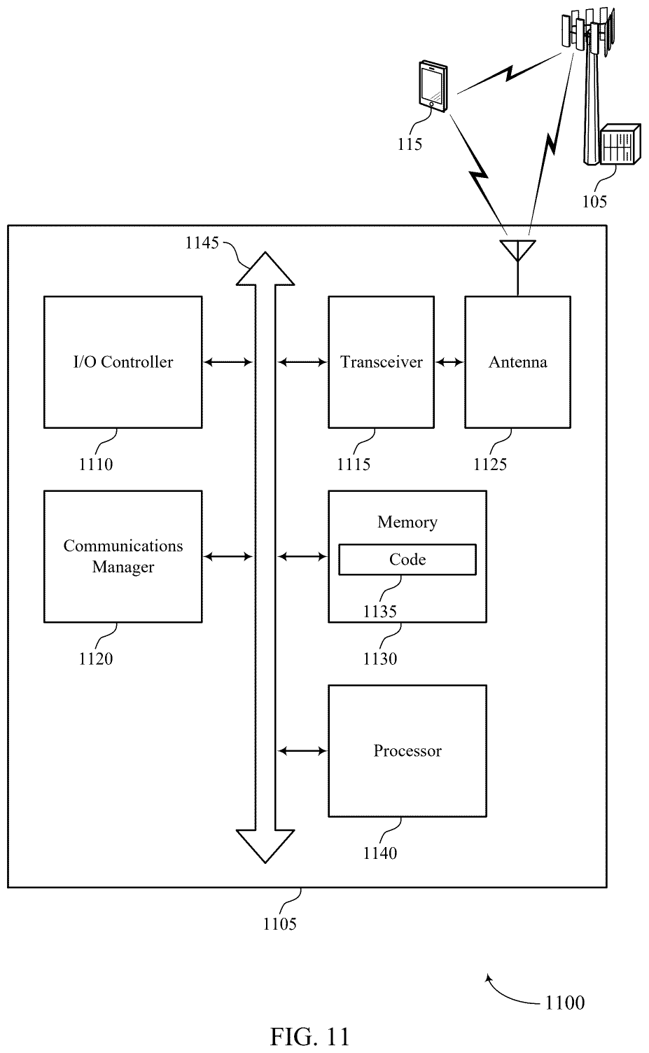

FIG. 11 shows a diagram of a system 1100 including a device 1105 that supports relaxed timeline for aperiodic channel state information reporting on an uplink shared channel in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting relaxed timeline for aperiodic channel state information reporting on an uplink shared channel). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for transmitting capability signaling indicating a power saving capability associated with two-part channel state information reporting. The communications manager 1120 is capable of, configured to, or operable to support a means for receiving, based on the capability signaling, control signaling including information triggering aperiodic two-part channel state information reporting. The communications manager 1120 is capable of, configured to, or operable to support a means for generating, based on the capability signaling, at least a part of a two-part channel state information report in accordance with a timeline that is in accordance with the control signaling, where the timeline differs from a default timeline associated with non-power saving channel state information reporting. The communications manager 1120 is capable of, configured to, or operable to support a means for transmitting at least the part of the two-part channel state information report via an uplink shared channel in accordance with the timeline.

Additionally, or alternatively, the communications manager 1120 may support wireless communications in accordance with examples as disclosed herein. For example, the communications manager 1120 is capable of, configured to, or operable to support a means for receiving, while in a first processing unit state associated with a first processing speed, control signaling triggering aperiodic two-part channel state information reporting, where the control signaling instructs the UE to generate a two-part channel state information report within a timeline. The communications manager 1120 is capable of, configured to, or operable to support a means for transitioning, based on the control signaling, from the first processing unit state to a second processing unit state associated with a second processing speed, the second processing speed faster than the first processing speed. The communications manager 1120 is capable of, configured to, or operable to support a means for generating, based on the control signaling and while in the second processing unit state, at least a part of the two-part channel state information report within the timeline. The communications manager 1120 is capable of, configured to, or operable to support a means for transmitting at least the part of the two-part channel state information report via an uplink shared channel.

By including or configuring the communications manager 1120 in accordance with examples as described herein, the device 1105 may support techniques for reduced power consumption, more efficient utilization of communication resources, longer battery life, and improved utilization of processing capability.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of relaxed timeline for aperiodic channel state information reporting on an uplink shared channel as described herein, or the at least one processor 1140 and the at least one memory 1130 may be otherwise configured to, individually or collectively, perform or support such operations.

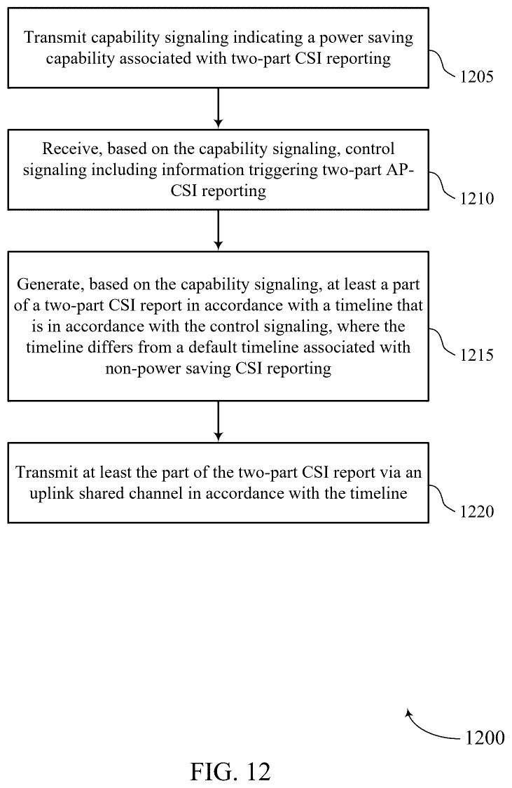

FIG. 12 shows a flowchart illustrating a method 1200 that supports relaxed timeline for AP-CSI reporting on an uplink shared channel in accordance with one or more aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include transmitting capability signaling indicating a power saving capability associated with two-part CSI reporting. The operations of 1205 may be performed in accordance with examples as disclosed herein. In some examples, aspects of the operations of 1205 may be performed by a power saving capability component 1025 as described with reference to FIG. 10.

At 1210, the method may include receiving, based on the capability signaling, control signaling including information triggering aperiodic two-part CSI reporting. The operations of 1210 may be performed in accordance with examples as disclosed herein. In some examples, aspects of the operations of 1210 may be performed by an AP-CSI trigger component 1030 as described with reference to FIG. 10.

At 1215, the method may include generating, based on the capability signaling, at least a part of a two-part CSI report in accordance with a timeline that is in accordance with the control signaling, where the timeline differs from a default timeline associated with non-power saving CSI reporting. The operations of 1215 may be performed in accordance with examples as disclosed herein. In some examples, aspects of the operations of 1215 may be performed by a processing timeline component 1035 as described with reference to FIG. 10.

At 1220, the method may include transmitting at least the part of the two-part CSI report via an uplink shared channel in accordance with the timeline. The operations of 1220 may be performed in accordance with examples as disclosed herein. In some examples, aspects of the operations of 1220 may be performed by an uplink component 1040 as described with reference to FIG. 10.

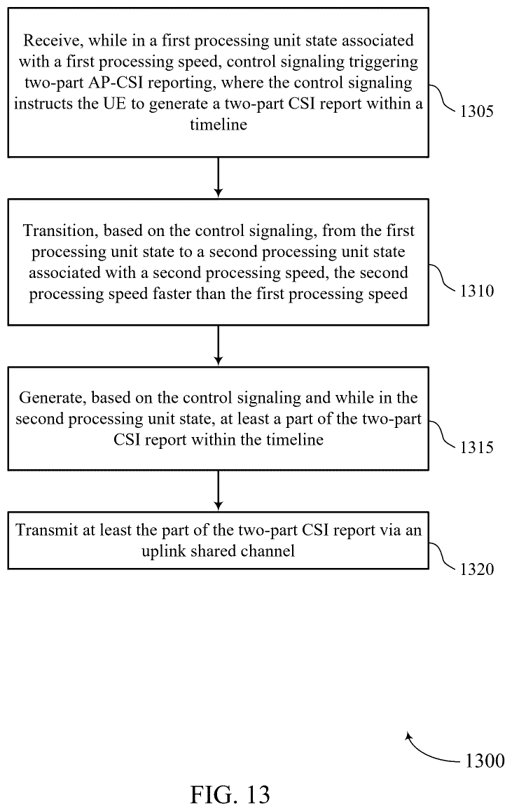

FIG. 13 shows a flowchart illustrating a method 1300 that supports relaxed timeline for AP-CSI reporting on an uplink shared channel in accordance with one or more aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1305, the method may include receiving, while in a first processing unit state associated with a first processing speed, control signaling triggering aperiodic two-part CSI reporting, where the control signaling instructs the UE to generate a two-part CSI report within a timeline. The operations of 1305 may be performed in accordance with examples as disclosed herein. In some examples, aspects of the operations of 1305 may be performed by an AP-CSI trigger component 1030 as described with reference to FIG. 10.

At 1310, the method may include transitioning, based on the control signaling, from the first processing unit state to a second processing unit state associated with a second processing speed, the second processing speed faster than the first processing speed. The operations of 1310 may be performed in accordance with examples as disclosed herein. In some examples, aspects of the operations of 1310 may be performed by a processing unit state component 1045 as described with reference to FIG. 10.

At 1315, the method may include generating, based on the control signaling and while in the second processing unit state, at least a part of the two-part CSI report within the timeline. The operations of 1315 may be performed in accordance with examples as disclosed herein. In some examples, aspects of the operations of 1315 may be performed by a processing unit state component 1045 as described with reference to FIG. 10.

At 1320, the method may include transmitting at least the part of the two-part CSI report via an uplink shared channel. The operations of 1320 may be performed in accordance with examples as disclosed herein. In some examples, aspects of the operations of 1320 may be performed by an uplink component 1040 as described with reference to FIG. 10.

The following provides an overview of aspects of the present disclosure:

The following provides an overview of aspects of the present disclosure:

Aspect 1: A method for wireless communications at a UE, comprising: transmitting capability signaling indicating a power saving capability associated with two-part CSI reporting; receiving, based at least in part on the capability signaling, control signaling comprising information triggering aperiodic two-part CSI reporting; generating, based at least in part on the power saving capability, a part of a two-part CSI report in accordance with a first timeline indicated by control signaling, wherein the timeline differs from a second timeline associated with non-power saving CSI reporting; and transmitting at least the generated part of the two-part CSI report via an uplink shared channel in accordance with the first timeline.

Aspect 2: The method of aspect, wherein receiving the control signaling further comprises: receiving an indication of a quantity of symbols of the first timeline, wherein the quantity of symbols of the first timeline is greater than a quantity of symbols of the second timeline associated with non-power saving CSI reporting.

Aspect 3: The method of aspect, wherein the indication of the quantity of symbols of the first timeline comprises an additional quantity of symbols relative to the quantity of symbols of the second timeline.

Aspect 4: The method of any of aspects through, wherein generating the generated part of the two-part CSI report further comprises: processing a first portion of the two-part CSI report prior to starting a processing of a second portion of the two-part CSI report, wherein processing the first portion of the two-part CSI report is independent of rank information associated with one or more CSI-RSs; and processing the second portion of the two-part CSI report based at least in part on the rank information associated with the one or more CSI-RSs.

Aspect 5: The method of aspect, wherein generating the generated part of the two-part CSI report further comprises: puncturing a payload of the two-part CSI report.

Aspect 6: The method of any of aspects through, wherein transmitting the generated part of the two-part CSI report further comprises: transmitting, based at least in part on the power saving capability, the generated part of the two-part CSI report using an assumed rank for a portion of the two-part CSI report.

Aspect 7: The method of any of aspects through, wherein the first timeline is based at least in part on a quantity of symbols after receiving the control signaling, a quantity of symbols after receiving a CSI-RS, or both.

Aspect 8: The method of any of aspects through, wherein the first timeline is based at least in part on the control signaling, based at least in part on static configuration information, or a combination thereof.

Aspect 9: The method of any of aspects through, wherein the generated part of the two-part CSI report comprises a second part of the two-part CSI report, the second part of the two-part CSI report comprises at least a precoding matrix indicator, and a first part of the two-part CSI report comprises at least an indication of a number of information bits associated with the second part of the two-part CSI report.

Aspect 10: A method for wireless communications at a UE, comprising: receiving, while in a first processing unit state associated with a first processing speed, control signaling triggering aperiodic two-part CSI reporting, wherein the control signaling instructs the UE to generate a two-part CSI report within a first timeline; transitioning, based at least in part on the control signaling, from the first processing unit state to a second processing unit state associated with a second processing speed, the second processing speed faster than the first processing speed; generating, based at least in part on the control signaling and while in the second processing unit state, a part of the two-part CSI report within the first timeline; and transmitting the generated part of the two-part CSI report via an uplink shared channel.

Aspect 11: The method of aspect, wherein the first timeline is based at least in part on a quantity of symbols after receiving the control signaling, a quantity of symbols after receiving a CSI-RS, or both.

Aspect 12: The method of any of aspects through, wherein the generated part of the two-part CSI report comprises a second part of the two-part CSI report, the second part of the two-part CSI report comprises at least a precoding matrix indicator, and a first part of the two-part CSI report comprises at least an indication of a number of information bits associated with the second part of the two-part CSI report.

Aspect 13: A UE for wireless communications, comprising a processing system that includes processor circuitry and memory circuitry that stores code, the processing system configured to cause the UE to perform a method of any of aspects through.

Aspect 14: A UE for wireless communications, comprising at least one means for performing a method of any of aspects through.

Aspect 15: A non-transitory computer-readable medium storing code for wireless communications, the code comprising instructions executable by one or more processors to perform a method of any of aspects through.

Aspect 16: A UE for wireless communications, comprising a processing system that includes processor circuitry and memory circuitry that stores code, the processing system configured to cause the UE to perform a method of any of aspects through.

Aspect 17: A UE for wireless communications, comprising at least one means for performing a method of any of aspects through.

Aspect 18: A non-transitory computer-readable medium storing code for wireless communications, the code comprising instructions executable by one or more processors to perform a method of any of aspects through.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit capability signaling indicating a power saving capability associated with two-part channel state information reporting;
receive, based at least in part on the capability signaling, control signaling comprising information triggering aperiodic two-part channel state information reporting;
generate, based at least in part on the power saving capability, a part of a two-part channel state information report in accordance with a first timeline indicated by the control signaling, wherein the first timeline differs from a second timeline associated with non-power saving channel state information reporting; and
transmit the generated part of the two-part channel state information report via an uplink shared channel in accordance with the first timeline.

2. The UE of claim 1, wherein, to receive the control signaling, the one or more processors are individually or collectively further operable to execute the code to cause the UE to:
receive an indication of a quantity of symbols of the first timeline, wherein the quantity of symbols of the first timeline is greater than a quantity of symbols of the second timeline associated with non-power saving channel state information reporting.

3. The UE of claim 2, wherein the indication of the quantity of symbols of the first timeline comprises an additional quantity of symbols relative to the quantity of symbols of the second timeline.

4. The UE of claim 1, wherein, to generate the generated part of the two-part channel state information report, the one or more processors are individually or collectively further operable to execute the code to cause the UE to:
process a first portion of the two-part channel state information report prior to starting a processing of a second portion of the two-part channel state information report, wherein processing the first portion of the two-part channel state information report is independent of rank information associated with one or more channel state information reference signals; and
process the second portion of the two-part channel state information report based at least in part on the rank information associated with the one or more channel state information reference signals.

5. The UE of claim 4, wherein, to generate the generated part of the two-part channel state information report, the one or more processors are individually or collectively further operable to execute the code to cause the UE to:
puncture a payload of the two-part channel state information report.

6. The UE of claim 1, wherein, to transmit the generated part of the two-part channel state information report, the one or more processors are individually or collectively further operable to execute the code to cause the UE to:
transmit, based at least in part on the power saving capability, the generated part of the two-part channel state information report using an assumed rank for a portion of the two-part channel state information report.

7. The UE of claim 1, wherein the first timeline is based at least in part on a quantity of symbols after receiving the control signaling, a quantity of symbols after receiving a channel state information reference signal, or both.

8. The UE of claim 1, wherein the first timeline is based at least in part on the control signaling, based at least in part on static configuration information, or a combination thereof.

9. The UE of claim 1, wherein the generated part of the two-part channel state information report comprises a second part of the two-part channel state information report, the second part of the two-part channel state information report comprises at least a precoding matrix indicator, and a first part of the two-part channel state information report comprises at least an indication of a number of information bits associated with the second part of the two-part channel state information report.

10. A user equipment (UE), comprising:
one or more memories storing processor-executable code; and
one or more processors coupled with the one or more memories and individually or collectively operable to execute the code to cause the UE to:
receive, while in a first processing unit state associated with a first processing speed, control signaling triggering aperiodic two-part channel state information reporting, wherein the control signaling instructs the UE to generate a two-part channel state information report within a first timeline;
transition, based at least in part on the control signaling, from the first processing unit state to a second processing unit state associated with a second processing speed, the second processing speed faster than the first processing speed;
generate, based at least in part on the control signaling and while in the second processing unit state, a part of the two-part channel state information report within the first timeline; and
transmit the generated part of the two-part channel state information report via an uplink shared channel.

11. The UE of claim 10, wherein the first timeline is based at least in part on a quantity of symbols after receiving the control signaling, a quantity of symbols after receiving a channel state information reference signal, or both.

12. The UE of claim 10, wherein the generated part of the two-part channel state information report comprises a second part of the two-part channel state information report, the second part of the two-part channel state information report comprises at least a precoding matrix indicator, and a first part of the two-part channel state information report comprises at least an indication of a number of information bits associated with the second part of the two-part channel state information report.

13. A method for wireless communications at a user equipment (UE), comprising:
transmitting capability signaling indicating a power saving capability associated with two-part channel state information reporting;
receiving, based at least in part on the capability signaling, control signaling comprising information triggering aperiodic two-part channel state information reporting;
generating, based at least in part on the power saving capability, a part of a two-part channel state information report in accordance with a first timeline indicated by control signaling, wherein the timeline differs from a second timeline associated with non-power saving channel state information reporting; and
transmitting at least the generated part of the two-part channel state information report via an uplink shared channel in accordance with the first timeline.

14. The method of claim 13, wherein receiving the control signaling further comprises:
receiving an indication of a quantity of symbols of the first timeline, wherein the quantity of symbols of the first timeline is greater than a quantity of symbols of the second timeline associated with non-power saving channel state information reporting.

15. The method of claim 14, wherein the indication of the quantity of symbols of the first timeline comprises an additional quantity of symbols relative to the quantity of symbols of the second timeline.

16. The method of claim 13, wherein generating the generated part of the two-part channel state information report further comprises:
processing a first portion of the two-part channel state information report prior to starting a processing of a second portion of the two-part channel state information report, wherein processing the first portion of the two-part channel state information report is independent of rank information associated with one or more channel state information reference signals; and
processing the second portion of the two-part channel state information report based at least in part on the rank information associated with the one or more channel state information reference signals.

17. The method of claim 16, wherein generating the generated part of the two-part channel state information report further comprises:
puncturing a payload of the two-part channel state information report.

18. The method of claim 13, wherein transmitting the generated part of the two-part channel state information report further comprises:
transmitting, based at least in part on the power saving capability, the generated part of the two-part channel state information report using an assumed rank for a portion of the two-part channel state information report.

19. The method of claim 13, wherein the first timeline is based at least in part on a quantity of symbols after receiving the control signaling, a quantity of symbols after receiving a channel state information reference signal, or both.

20. The method of claim 13, wherein the first timeline is based at least in part on the control signaling, based at least in part on static configuration information, or a combination thereof.
